(19) United States
(12) Patent Application Publication
(10) Pub. No.: US 2016/0072362 A1
(43) Pub. Date: Mar. 10, 2016

(54) Hybrid Axial Flux Machines and Mechanisms

(71) Applicant: Steve Michael Kube, Clemmons, NC (US)

(72) Inventor: Steve Michael Kube, Clemmons, NC (US)

(21) Appl. No.: 14/478,904

(22) Filed: Sep. 5, 2014

(51) Int. Cl. H02K 7/14; H02K 7/00; H02K 1/14; H02K 3/32; H02K 1/27; H02K 3/28

(52) U.S. Cl. CPC H02K 7/14; H02K 1/2793; H02K 3/28; H02K 1/14; H02K 3/325; H02K 7/00; H02K 2203/12

(57) ABSTRACT

an axial flux electric motor having one or more permanent magnets (91) in a rotor that combines the functions of one or more rotor elements of a second machine or mechanism with the rotor of the axial flux electric motor, such as a gear driver of a gear pump (96), a vane rotor of a vane pump (130), an impeller of a turbine type axial flow pump (160), a vane rotor of a vane compressor (190), a swash plate of an axial piston machine (222), an eccentric (220), a cam (224), or a roller rotor (227) or other rotor elements to create smaller, lighter, more efficient machines and mechanisms that can also be modular in construction, sharing various common components across a wide range of these hybrid machines and mechanisms.

### FIELD OF INVENTION

This invention relates to pumps, compressors, and other machines and mechanisms having integral electric motors.

### BACKGROUND

The most prevalent integral, or hybrid electric motor and pump machine is the centrifugal pump commonly used in aquariums, ponds, fountains, statuary, and many other applications. These pumps have a motor and pump integrated, sharing components, and they have two chief problems: They do not generate very much head pressure and they are not very energy efficient.

One way to overcome the lack of head pressure and lack of energy efficiency inherent in these hybrid centrifugal pumps is to use a positive displacement pump with a separate motor to drive them, such as a stepper, multi-phase, or synchronous motor for example, which adds expense, complexity and introduces various potential problems. For example; most motors are not submersible, and while some motors may be made so, this adds expense and complexity. Additionally, unless expensive magnetic couplings are used to drive the positive displacement pump, shaft seals, which can fail and leak, will need to be used.

### SUMMARY

At the heart of the present invention an axial flux electric motor is integrated with a second machine in a novel manner which allows for hybrid positive displacement pumps, compressors, and other machines and mechanisms, through a hybrid, or dual purpose rotor which is integral to both machines, thus eliminating couplings and shaft seals, while reducing raw material and cost. Additionally, a modular method of manufacturing and construction of the present invention allows an integral axial flux electric motor to be of a stepper, multi-phase, or synchronous variety, among several other features this modularity allows.

### OBJECTS AND ADVANTAGES

Accordingly, several objects and advantages of the present invention are:

(a) to provide a hybrid axial flux positive displacement pump having components common to both the motor and the pump, thereby reducing the amount of raw materials used, lowering the overall cost of tooling and other manufacturing costs,
(b) to provide a hybrid axial flux positive displacement pump that does not need a separate motor coupled to it for motive power, thus providing a simpler solution to the end user.
(c) to provide a range of hybrid axial flux machines that share modular components, therefore increasing production of those modular components and reducing overall costs.
(d) to provide hybrid axial flux machines that are easy to manufacture in high volume.
(e) to provide hybrid axial flux machines that can utilize a variety of controller and drive schemes, including simple, sophisticated, and integrated controllers and drivers, or in some arrangements to be able to run without a driver or controller.
(f) to provide hybrid axial flux pumps that are more energy efficient than currently available hybrid pumps
(g) to provide hybrid axial flux machines that can be driven with stepper motor schemes, multi-phase motor schemes, or with synchronous motor schemes; with only minor changes, using many components common to the various schemes.
(h) to provide a new method of producing synchronous machines using a roller clutch bearing to allow the rotor to turn in one direction only.
(i) to provide hybrid axial flux gear pumps, vane pumps, and turbine or impeller pumps.
(j) to provide hybrid axial flux compressors that are smaller; weigh less, use less raw material, provide increased torque, increased energy density, and are lower cost to tool and manufacture than compressors of the prior art.
(k) to provide hybrid axial flux compressors, particularly for electric and hybrid electric car air conditioning systems, that are smaller, and lighter than the prior art.

(l) to provide hybrid axial flux compressors that can run on different power schemes, including stepper, multi-phase and synchronous AC with minor changes.

(m) to provide hybrid axial flux vane compressors.
(n) to provide hybrid axial flux swash plate machines and mechanisms that can be used in other machines such as axial piston pumps and compressors.
(o) to provide hybrid axial flux eccentric rotor machines and mechanisms that can be used to make diaphragm pumps, rotary piston pumps and more.
(p) to provide hybrid axial flux cam rotor machines and mechanisms that can be used in various other machines.
(q) to provide hybrid axial flux machines and mechanisms that can be used to make peristaltic pumps.
(r) to provide hybrid axial flux gear drives that can be used to make rack and pinion machines and mechanisms.
(s) to provide hybrid axial flux gear drives that can be used to make planetary gear machines and mechanisms.
(t) to provide hybrid axial flux gear drives that can be used to make spur gear machines and mechanisms.
(u) to provide modular hybrid axial flux machines and mechanisms that share common components across a wide range of machines, mechanisms and products.
(v) to provide modular discrete components that combine to make modular sub-assemblies that are then used to create modular hybrid axial flux machines and mechanisms.
(w) to provide hybrid axial flux machines that are readily understood and can be implemented using currently supported motor drive schemes, such as bipolar stepper, unipolar stepper, three phase, inverted three phase, and synchronous, using existing logic and integrated circuits, and discrete components, or with no driver or controller at all when using synchronous drive schemes.
(x) to provide hybrid axial flux machines that can be used to convert mechanical energy into electrical energy.

Further objects and advantages will become apparent from a consideration of the ensuing description and drawings.

### DESCRIPTION OF DRAWINGS

FIG. 1 is an assembled stepper style hybrid axial flux gear pump embodying the principles of the present invention.

FIG. 2 is an exploded view of a vented stator cup and cap.

FIG. 3 is an exploded view of the hybrid axial flux gear pump of FIG. 1

FIG. 4 is a four pole driver and gear assembly embodying the principles of the present invention.

FIG. 5 is an exploded view of the four pole driver and gear assembly of FIG. 3

FIG. 6A through 6D illustrate the steps used to create rotary motion in the four pole stepper style motor embodying the principles of the present invention.

FIG. 7 is an assembled three phase hybrid axial flux vane pump embodying the principles of the present invention

FIG. 8 is an exploded view of the hybrid axial flux vane pump shown in FIG. 7

FIG. 9 is a hybrid axial flux vane pump driver embodying the principles of the present invention.

FIG. 10 is an exploded view of the hybrid axial flux vane pump driver of FIG. 9

FIG. 11A through 11D illustrate the steps used to create rotary motion in one embodiment of a three phase version of the present invention.

FIG. 12 shows a socket for a four pole stator embodying the principles of one embodiment of the present invention.

FIG. 13 shows a socket for a six pole stator embodying the principles of one embodiment of the present invention.

FIG. 14 shows a synchronous hybrid axial flux, axial flow pump embodying the principles of one embodiment of the present invention.

FIG. 15 is a partially exploded view of the pump shown in FIG. 14.

FIG. 16 is a more fully exploded view of the pump shown in FIG. 15.

FIG. 17 is a partially exploded view of the stator and rotor of FIG. 16.

FIG. 18A and 18B illustrate the steps used to create rotary motion in one embodiment of a six pole synchronous version of the present invention.

FIG. 19 illustrate the steps used to create rotary motion in one embodiment of a 4 pole synchronous version of the present invention.

FIG. 20 illustrate the steps used to create rotary motion in one embodiment of a 2 pole synchronous version of the present invention.

FIG. 21 shows components used to make four and six pole stator assemblies embodying the principles of the present invention.

FIG. 22 shows modular stator assemblies and a permanent magnet set embodying the principles of the present invention.

FIG. 23 shows hybrid gear rotor, vane rotor, and turbine rotor embodying the principles of the present invention.

FIG. 24 shows a gear pump, vane pump, and an axial flow pump embodying the principles of the present invention.

FIG. 25 is a table of some potential combinations inherent in various embodiments of the present invention.

FIG. 26 shows an assembled refrigeration compressor embodying the principles of the present invention.

FIG. 27 shows the partially exploded refrigeration compressor of FIG. 27

FIG. 28 shows a more fully exploded refrigeration compressor of FIG. 28

FIG. 29 shows a cutaway view A-A of compressor chamber sleeve 200 shown in FIG. 28, together with a cutaway view B-B of compressor case half 184 shown in FIG. 28.

FIG. 30 is an enlarged view of reed valve 185 shown. in FIG. 28

FIG. 31 is a cutaway view of compressor case shown in FIG. 28 with chamber sleeve in place, more clearly illustrating passageways in compressor case.

FIG. 32 is an exploded view of a four pole refrigeration compressor assembly embodying the principles of the present invention.

FIG. 33 shows a hybrid axial flux swash plate rotor embodying the principles of the present invention.

FIG. 34 shows a hybrid axial flux eccentric rotor embodying the principles of the present invention.

FIG. 35 shows the eccentric rotor of FIG. 34 in plan view

FIG. 36 shows a hybrid axial flux cam rotor embodying the principles of the present invention.

FIG. 37 shows the axial cam rotor of FIG. 36 in plan view

FIG. 38 shows a plan view of a peristaltic pump embodying the principles of the present invention.

FIG. 39 shows a hybrid axial flux gear driver and driven gear of one embodiment of the present invention.

FIG. 40 shows a planetary gear system having a hybrid axial flux gear rotor of one embodiment of the present invention.

FIG. 41 shows a hybrid axial flux pinion rotor with rack embodying principles of the present invention.

FIG. 42 is a short electrical steel lamination

FIG. 43 is a tall electrical steel lamination

FIG. 44 is a tall stack of electrical steel laminations and two square bobbins with coils

FIG. 45 is a short stack of electrical steel laminations and two square bobbins with coils.

FIG. 46 is a four pole driver and gear assembly embodying the principles of the present invention.

FIG. 47 is an exploded view of a four pole driver and gear assembly of FIG. 46.

FIG. 48 is a partially exploded view of a four pole synchronous gear driver embodying principles of the present invention.

FIG. 49 is a partially exploded view of a four pole synchronous gear driver assembly embodying principles of the present invention.

FIG. 50 is a four pole synchronous gear driver assembly embodying principles of the present invention.

FIG. 51 shows a partially coiled electrical steel stator embodying principles of the present invention.

FIG. 52 shows a bottom plan view of a coiled electrical steel stator assembly with bobbins embodying principles of the present invention.

FIG. 53 shows a top plan view of a coiled electrical steel stator assembly with bobbins embodying principles of the present invention.

### Description of invention

### Stepper Drive Scheme

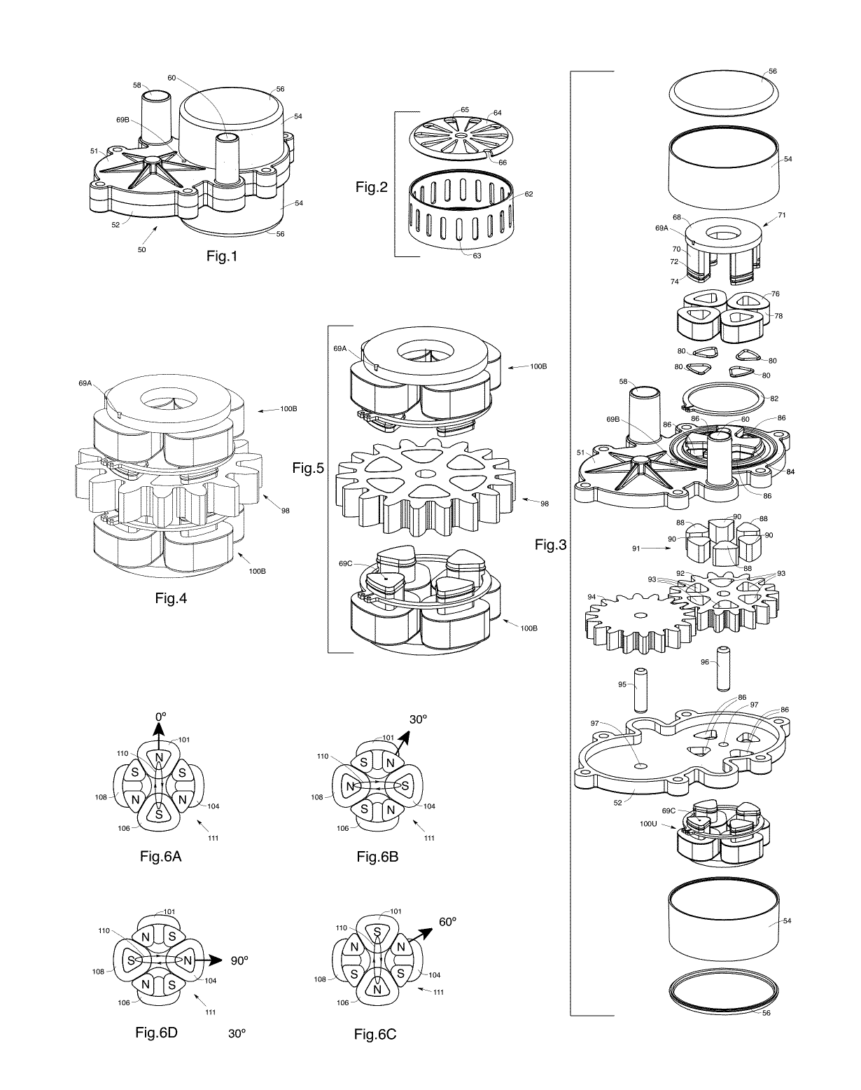

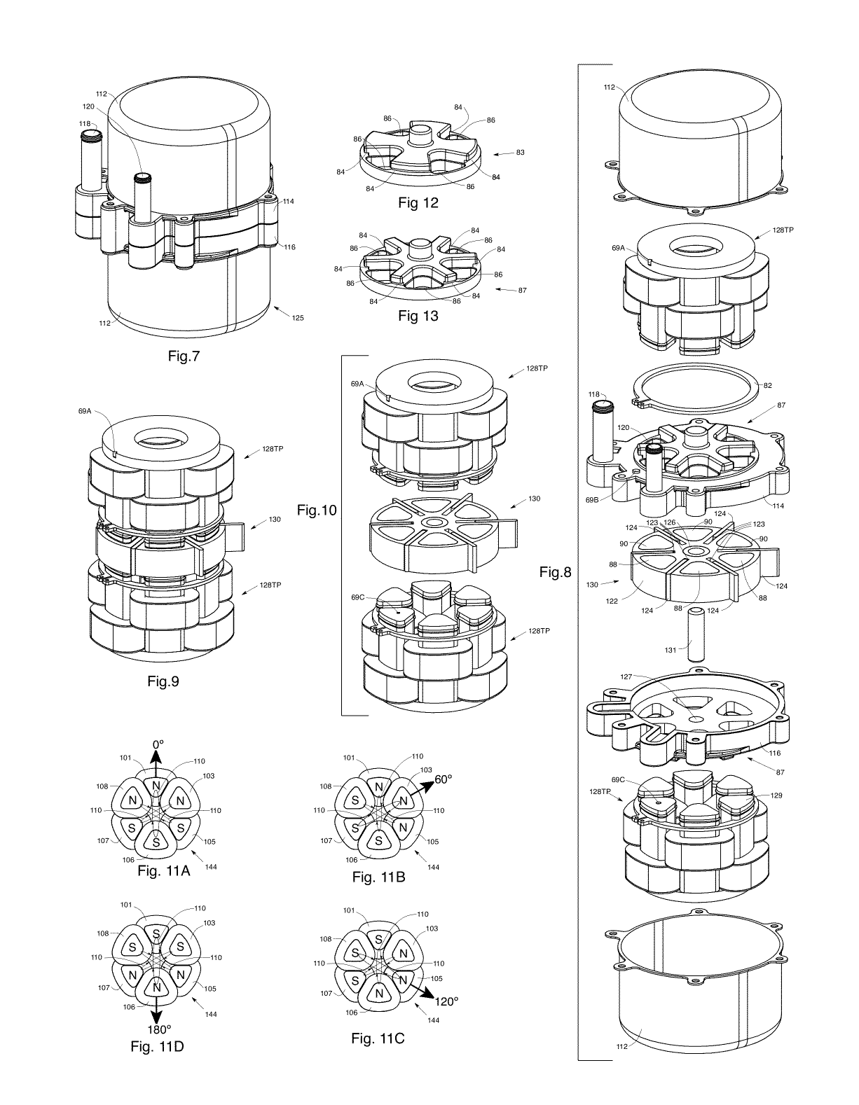

One embodiment of the present invention is the hybrid axial flux gear pump illustrated in FIG. 1 through FIG. 6C. The housing halves 51 and 52 FIG. 1 and FIG. 3 may be injection molded plastic such as polycarbonate, HDPE, nylon, PP, etc., they may also be cast metal, powdered metal or of other suitable non-ferrous material, and made using any acceptable manufacturing methods, including emerging methods as with 3D printing, laser sintering, etc. Case half 51 further comprises intake port 58, output port 60, and stator alignment mark 69B.

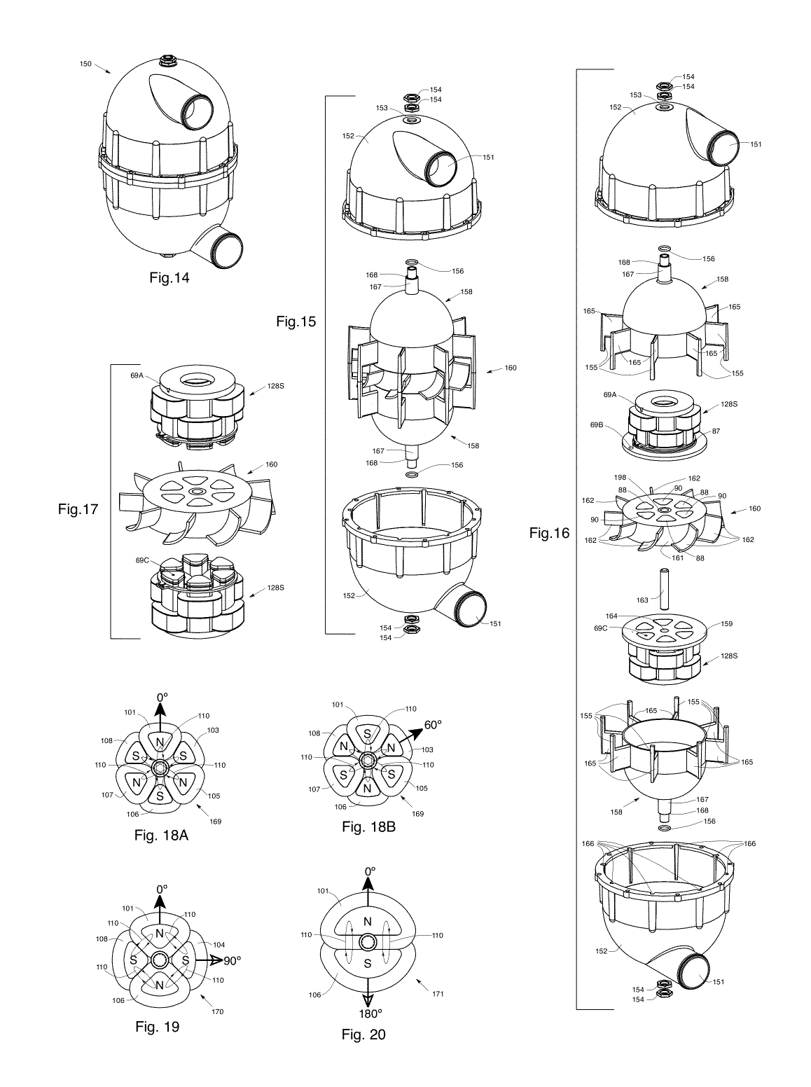

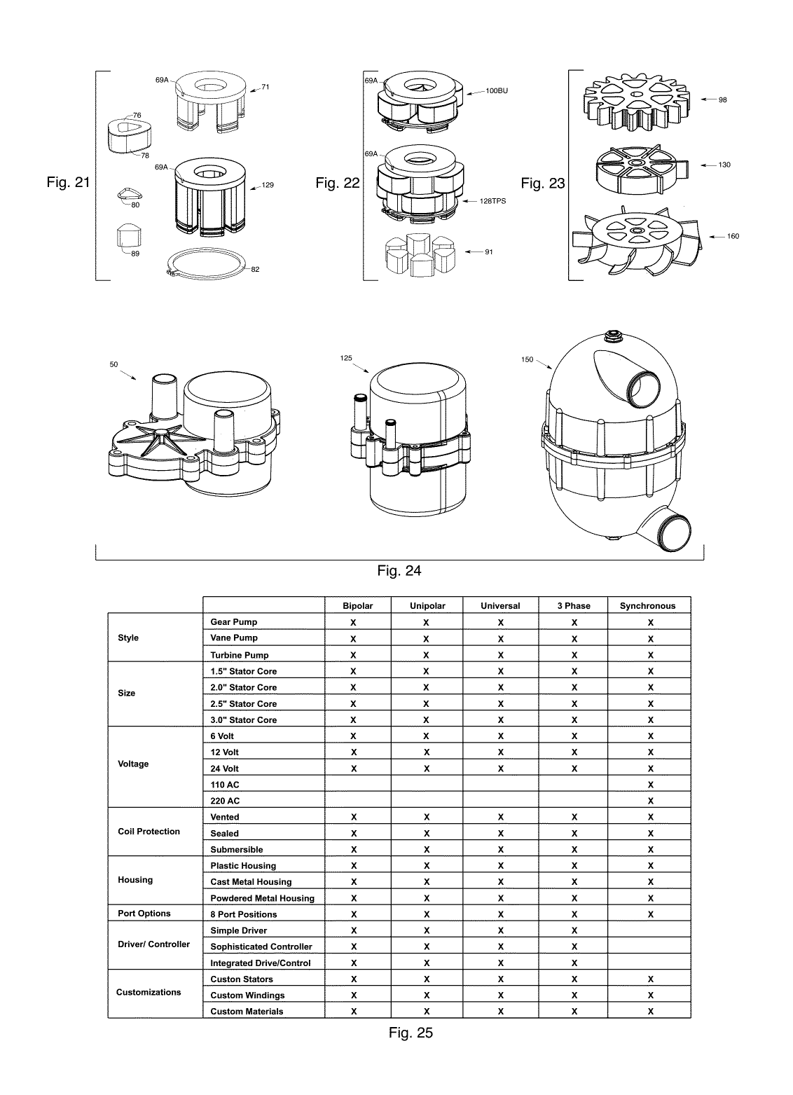

Sealed stator cups 54, and sealed stator caps 56 FIG. 1 and FIG. 3 may be metal, plastic or other suitable material and may snap onto housing halves 51 and 52 using snap-on features commonly known to those having ordinary skill in the art, or may be affixed thereto by other suitable methods. The stator cups and stator caps may be sealed FIG. 1 and FIG. 3, or they may be vented, with stator cup vent holes 63, and stator cap vent holes 65 FIG. 2.

Stator 71 FIG. 3 is made of insulated powdered metal, and comprises stator cores 70, flux return path 68, alignment notch 69A, O-ring groove 74, and circlip groove 72.

Stator assembly 100 FIG. 3, FIG. 4, FIG. 5 comprise stator 71, coils 78 wound on bobbins 76, O-rings 80, and circlip 82 FIG. 3.

Gear rotor 92 is made of non-ferrous material such as nylon, polyethylene, vinyl, polypropylene, aluminum, magnesium or a suitable alloy or other suitable combination of materials. Permanent magnet holes 93 are sized to accept and firmly hold permanent magnets 88 and 89. Permanent magnets 88 and 89 may be affixed to gear rotor 92 using adhesive (not shown), snap in elements (not shown) or by other methods known to those having ordinary skill in the art. Optionally, gear rotor 92 may be made in two halves (not shown), with sockets 93 for permanent magnets 88 and 89, and the two halves of optional gear rotor 92 may be snapped together, glued, welded or otherwise affixed together, holding permanent magnets 88 and 89 firmly inside the assembled gear rotor, and holes 93 could optionally not be through holes as shown, and could have solid membrane over the surface of the face of the gear, sealing permanent magnets inside of gear rotor 92. Gear Rotor assembly 98 FIG. 4 and FIG. 5, rotates on gear shaft 96 FIG. 3 and comprises a gear 92 and a permanent magnet set 91 FIG. 3.

Driven Gear 94 FIG. 3 rotates on driven gear shaft 95 and engages the gear rotor assembly 98. Driven gear 94 is made of a suitable polymer such as nylon, polyethylene, vinyl, polypropylene, etc. or of non-ferrous metal such as aluminum, magnesium, etc. or suitable alloys or other combinations of materials.

Gear shafts 95 and 96 are held fast in shaft holes in pump housing halves 51 and 52 FIG. 3 and can be substantially non-ferrous stainless steel or other suitable material.

Permanent magnet set 91 comprises six permanent magnets with magnetization in the axial direction and having upward facing poles 88 and 90 alternating North-South-North-South-North-South respectively.

Stator assemblies 100 FIG. 4 are aligned mechanically as well as electromagnetically to one another through gear rotor assembly 98 so the electromagnetic fields may interact most beneficially through permanent magnet set 100 to urge the gear rotor to rotate in the desired direction with optimal speed, and force.

Circlip 82 FIG. 3 engages in circlip groove 72 FIG. 3 and in socket groove 84 FIG. 3 to hold stator assembly 100 in position in pump halves 51 and 52 FIG. 1 and FIG. 3 and may be made of predominantly non-ferrous metal, such as suitable grades of stainless steel. Circlip 82 may alternatively comprise a simple formed wire retainer ring that could be of similar non-ferrous material. In some cases circlip 82 may even be made of plastic, particularly if stator assembly 100 will be potted, which will hold stator assembly 100 securely in place.

O-rings 80 FIG. 3 seal between stator 71, particularly at the bottom of stator core 70 FIG. 3 and stator socket holes 86 FIG. 3

Stator/Coil relationships FIG. 6A through FIG. 6C illustrate the four pole stepper motor style of this first embodiment of the present invention and will be discussed further in the operation section.

### Three Phase Drive Scheme

A second embodiment of the present invention is the hybrid axial flux vane pump illustrated in FIG. 7 through FIG. 11D. The housing halves 114 and 116 FIG. 7 and FIG. 8 may be injection molded plastic such as polycarbonate, HDPE, nylon, PP, etc., cast metal, powdered metal or other suitable non-ferrous material. Housing half 114 further comprises intake port 118, output port 120 and stator alignment mark 69B.

Stator covers 112 FIG. 1 and FIG. 3 may be metal, plastic or other suitable material and may snap onto housing halves or may be affixed thereto by other suitable means. The stator covers may be sealed FIG. 7 and FIG. 8 or they may be vented, as in the previous embodiment FIG. 2

Six Pole Stator assembly 128TP FIG. 8, FIG. 9, FIG. 10 comprises a powdered metal stator having six cores 129, coils 78 wound on bobbins 76, O-rings 80, and circlip 82 FIG. 3. The wiring (not shown) of assembly 128T is suited to a Three Phase drive scheme.

Vane Rotor assembly 130 FIG. 8, FIG. 9, FIG. 10 comprises a vane rotor 122, vanes 124, and a permanent magnet set 91 FIG. 3.

Vane rotor shaft 131 is held fast in shaft holes 127 in pump housing halves 114 and 116 FIG. 8

Permanent magnets 88 and 90 FIG. 8 have an axial direction of magnetization in a pattern of North-North-North-South-South-South respectively which is suited for three phase operation illustrated in this second embodiment of these hybrid axial flux machines.

Stator assemblies 128TP FIG. 8, FIG. 9 and FIG. 10 are aligned mechanically as well as electromagnetically to one another through vane rotor assembly 130 so the electromagnetic fields may interact most beneficially with one another and through permanent magnet set 100 to urge the gear rotor to rotate in the desired direction with optimal speed, and force.

As with the first described embodiment of the present invention, circlip 82 engages in stator circlip groove 72 and in socket groove 84 FIG. 8 to hold stator assembly 128TP in position in pump halves 114 and 116 FIG. 7 and FIG. 8

As with the first described embodiment of the present invention, O-rings 80 FIG. 3 seal between stator 128TP FIG. 8 and stator socket holes 86 FIG. 3 and FIG. 8

Stator/Coil relationships FIG. 11A through FIG. 11D illustrate the six pole three phase motor style of this second described embodiment of the present invention. Electromagnetic flux 110 FIG. 11A through FIG. 11D is generated in a sinusoidal fashion to urge permanent magnets N and S to rotate, and will be described more fully in the operation section.

### Synchronous Drive Scheme

A third embodiment of the present invention is the hybrid axial flux turbine, or axial flow pump illustrated in FIG. 14 through FIG. 20 The housing halves 152 FIG. 14, FIG. 15 and FIG. 16 may be injection molded plastic, cast metal, powdered metal or other suitable manufacturing technique using any other suitable material.

Inner Shell 158 FIG. 14, FIG. 15 and FIG. 16, may be injection molded, cast or powdered metal, or other suitable material using acceptable manufacturing methods

Six Pole Stator assembly 128S FIG. 16 and FIG. 17 are constructed similar to the three phase stator assembly described in the vane pump of the second embodiment, but with a wiring scheme suited to synchronous operation.

Stator assemblies 128S FIG. 15, FIG. 16 and FIG. 17 are sealed inside inner shell 158, and may be potted in epoxy or other suitable material to further insulate them electrically, and isolate them from possible contact with the fluid flowing through the pump 150.

Axial flow rotor assembly 160 FIG. 15, FIG. 16, FIG. 17 comprises a turbine type impeller rotor and a permanent magnets 88 and 90 FIG. 3, and further comprises a roller-clutch bearing 198 that will rotate in one direction only on rotor shaft 131 which is held fast in shaft holes 161 in stator sockets 87 FIG. 16

Permanent magnets 88 and 90 have an axial direction of magnetization and having alternating poles 88 and 90 in a pattern of North-South-North-South-North-South respectively, the same as with the stepper style rotor, but now to be used in a synchronous AC operation.

Stator assemblies 128S FIG. 16, FIG. 17 are aligned mechanically as well as electromagnetically to one another through turbine rotor assembly 160 so the electromagnetic fields may interact most beneficially through permanent magnet set 91 to urge the gear rotor to rotate in the desired direction with optimal speed, and force.

As with the previous embodiments of the present invention, circlip 82 FIG. 8 engages in stator circlip groove 72 FIG. 3 and in socket groove 84 FIG. 3 to hold stator assembly 128S in position in stator socket 87, which is integral with inner shell face 159 FIG. 16

As with the first and second described embodiments of the present invention, O-rings, 80 FIG. 3 seal between stator 128S FIG. 8 and stator socket holes 86 FIG. 3

Stator/Coil relationships FIG. 18A and FIG. 18B illustrate a six pole synchronous motor style of this third embodiment of the present invention. FIG. 20 illustrates a four pole synchronous motor style, and FIG. 21 illustrates a 2 pole synchronous motor style of this third embodiment of the present invention.

Wire passage tube 164 extends from inner shell 158 through hole 153 in outer shell 152 and is of sufficient size to allow for the stator wiring to pass from the stator coils in the interior to the exterior of pump 150 and to allow or potting material (not shown) to be introduced to interior of inner shell 158. Jamb nuts 154 FIG. 15, FIG. 16, secure inner shell 158 FIG. 16 FIG. 15, and FIG. 16 to outer shell half 152.

Turbine impeller 160 FIG. 16 can be made of injection molded plastic, cast non-ferrous metals, or other suitable material using suitable manufacturing methods and may be made to have blades of different pitches, allowing the impeller to be swapped out with an impeller having blades with a shallower pitch, or a steeper pitch as best suits the specific application to which it will be used in. A shallower pitch blade providing greater lift, or head pressure, or a steeper pitch to provide greater flow rate at a lower head pressure.

### Modularity

Careful consideration of the first three described embodiments of the present invention will reveal the inherent ability to mix and match components of these various embodiments in different ways to create a wider range of embodiments, each of which may be more suited to a particular application. Components and assemblies shown in FIG. 22 through FIG. 25 may be employed in different combinations to create hybrid axial flux pumps of different varieties, as illustrated in the table shown in FIG. 25.

One may take several approaches to determine which components should best be used to achieve the desired pump. For example, one may begin by deciding on a particular style of pump, gear, vane or turbine, and adding options afterwards. Or, one may begin by deciding on how it will be driven electrically, e.g. using the stepper drive scheme (wired as bipolar, unipolar, or universal), the 3 phase drive scheme, or the synchronous, and going from there. Similarly, the size of the stator core may be used as a foundation, then options would be selected to further refine the choice.

Note that in these first three described embodiments the stator cores 70 of both the 4 pole stator 71 and 6 pole stator 128 of a given outside diameter are identical in cross section, allowing bobbins and coils to fit on either the 4 pole stator 71 or 6 pole of stator 128. Bobbins that fit on a 4 pole stator 71 in a single layer will also fit on a 6 pole stator 128. The inner profile of the bobbins 76 used on 4 pole stators 71 and 6 pole stators 128 having the same stator outside diameter are identical, while the outer profile of bobbins 76 may also be identical, or may vary from 4 pole stator 71 to 6 pole stator 128. Put another way, bobbins sized to fit on 6 pole stators will also fit on 4 pole stators, when the flux return paths of both stators have the same outside diameter.

Also note that a particular size outside diameter of 4 pole and 6 pole stator can be used in any style of pump made to fit that size outside diameter of stator when used with the proper stator socket. Also note that any of the electromagnetic drive schemes, stepper, 3 phase, or synchronous, may be used, with any suitable voltages, such as those listed in the table of FIG. 25 (plus many others not listed). We use the same O-rings, and the same circlips, or other suitable retaining ring (not shown) for all of the models having a flux return path with the same outside diameter. Each of these components being modular, they useable in a wide range of products.

Additionally, by providing molds (not shown) or other tooling (not shown) with inserts (not shown) to manufacture either 4 pole sockets FIG. 12, or 6 pole sockets FIG. 13, the same tooling can be used to manufacture pumps that will use either the 4 pole stators, or 6 pole stators, thus greatly increasing the potential for using modular components to manufacture and use these hybrid axial flux machines and mechanisms.

The minimal set of modular components; bobbins, coils, O-rings, 4 pole stators, 6 pole stators, circlips, and permanent magnets, FIG. 21 can be assembled in different combinations to create 4 pole stator subassembly 100B, 4 pole stator subassembly 1000, 6 pole stator subassembly 128T, or 6 pole stator subassembly 128S, and permanent magnet set 91 FIG. 23, with permanent magnet set 91 having different combinations of orientations of magnetic poles north and south as desired.

The subassemblies 100B, 100U 1281, 128S and 91 FIG. 22 can then be used in combination with hybrid axial flux gear rotor, hybrid axial flux vane rotor, or hybrid axial flux turbine rotor, FIG. 23. Including a roller clutch bearing in the hybrid rotors to use with the synchronous drive schemes.

Bobbins may be of a length suitable for containing a coil of maximum size for optimal generation of an electromagnetic field with a given wire gauge and a given voltage utilized on 4 or 6 pole stators. Smaller coils may be wound on the same length bobbin to be utilized with other voltages, thus increasing the use of modular components to create a wide range of hybrid axial flux pumps. Alternately, bobbins of different lengths and outside diameters, or profiles, may be used.

Permanent magnets 89 may be manufactured with different magnetic strengths to optimize them for specific purposes depending on strength of the electromagnetic field that will be generated in the hybrid axial flux machine they will be used in and the purpose they are intended for. However, in one embodiment permanent magnets 89 are manufactured with predominantly uniform magnetic strength for general purpose use.

Hybrid axial flux gear pumps 50 and hybrid axial flux vane pumps 125 of the present invention may optionally further be optimized for their specific purposes by a choice of coil protection having a sealed or vented cup and cap, or by potting the coils to make them submersible.

Additionally, the construction of the hybrid axial flux pump housings may be molded plastic, or cast or powdered metal, or machined out of solid materials, or made using other emerging manufacturing methods.

A further expansion of possible variations is the possible positions of intake and output ports of the various pumps. There are 8 possible positions for the inlet and outlet ports, which can be significant to those wishing to integrate the hybrid axial flux pumps of the present invention into tight spaces with limited room for plumbing.

The stepper style and 3 phase style hybrid axial flux machines of the present invention may utilize a simple circuit (not shown) to drive them at a given speed for example, or they may utilize a more sophisticated circuit (not shown) that could provide a range of options such as speed control, one or more timers, various input control functions that may use the output of various sensors like temperature, or pressure sensors, or even light sensors to control the pump speed for instance. Furthermore, the hybrid axial flux pump drivers and controllers may be integral with circuitry used in other functions in a particular application. For example, the temperature sensor of a CPU or GPU chip may be used to control the speed of the hybrid axial flux pump of the present invention to speed up the flow of coolant used to regulate the CPU or GPU temperature as the temperature rose, and to slow down the flow of coolant as the temperature dropped, minimizing energy use and reducing noise associated with cooling pumps. This also illustrates the variable speed nature of these hybrid axial flux pumps, which is not inherent in typical hybrid centrifugal pumps commonly used in CPU cooling and other applications.

Still further expansion on the possibilities of using modular components is with customization of some of the components so the purposes for which these hybrid axial flux machines and mechanisms may be used can be tailored to an even broader range of applications. Custom length stators for example could hold longer bobbins, or multiple sets of smaller bobbins for example. Custom windings of coils can further tailor these pumps to even more specific applications. Custom materials, such as inclusion of an antimicrobial in the materials used, or use of natural antimicrobial materials such as copper or silver for example in the housing, or rotors, or other components for example.

### Description and Operation of Alternative Embodiments

### Three Phase Refrigeration Compressor

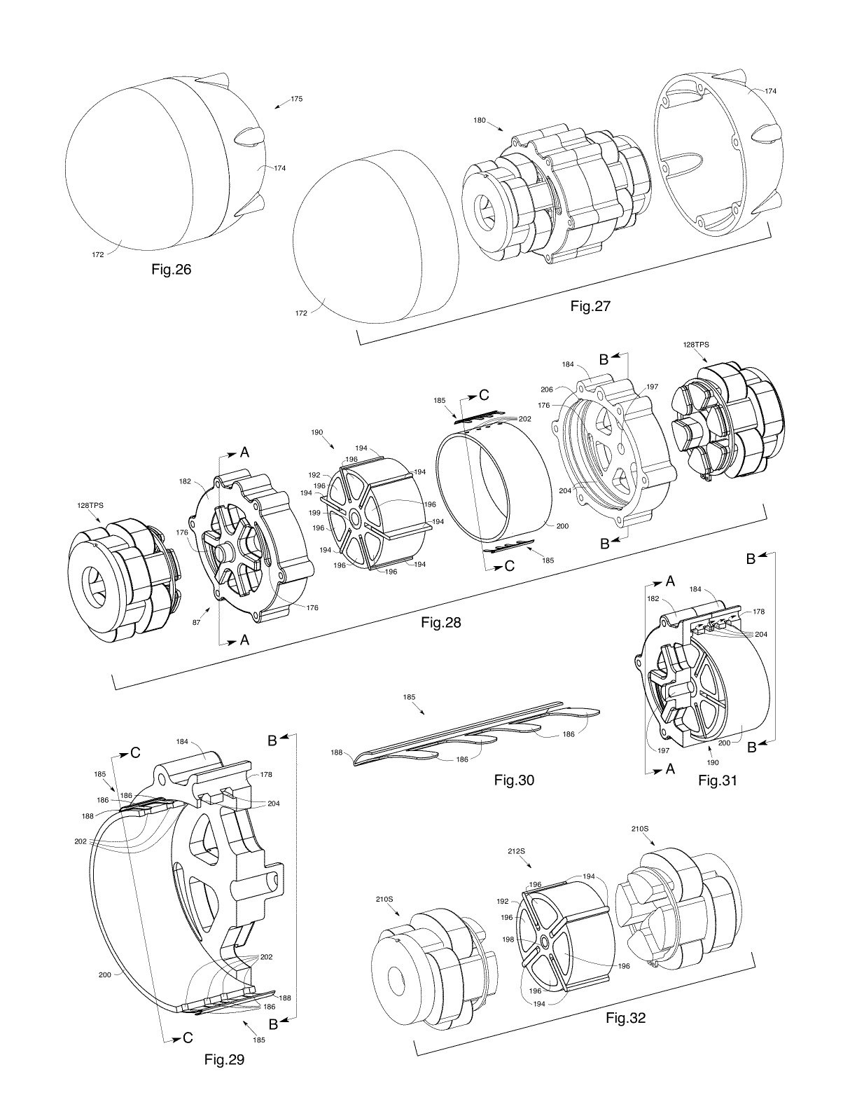

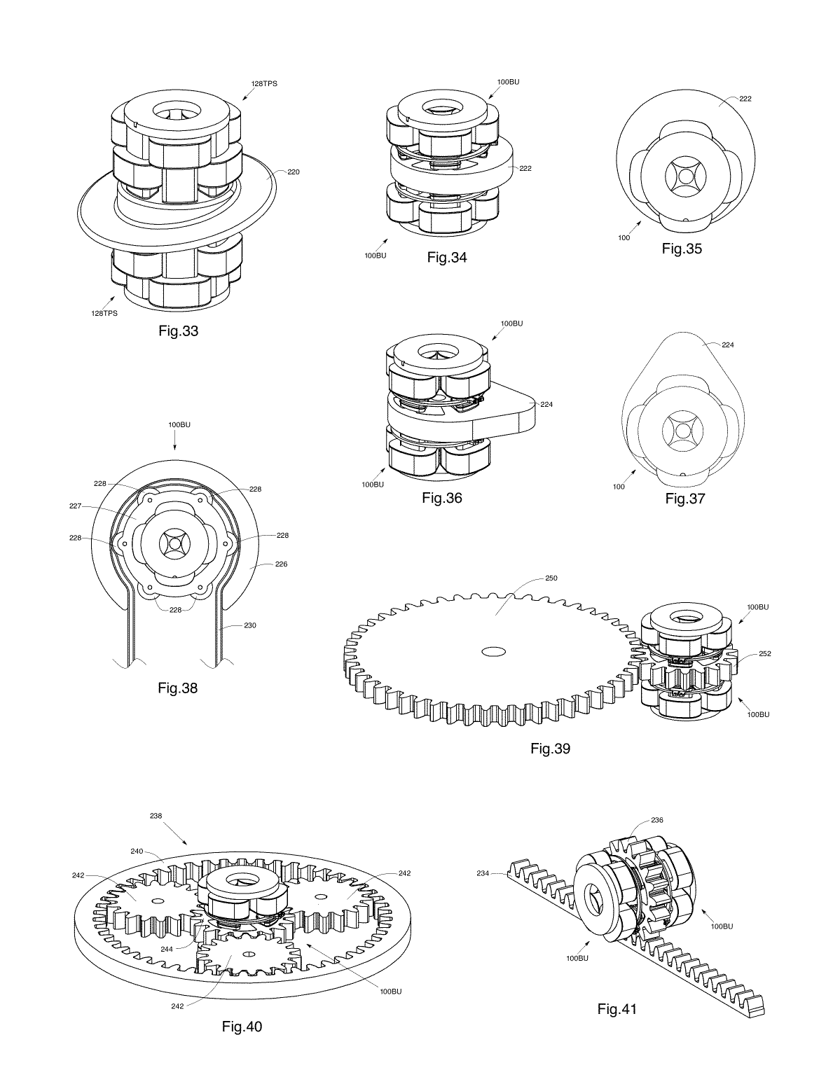

An alternative embodiment of the present invention is the hybrid axial flux vane compressor illustrated in FIG. 26 through FIG. 32. FIG. 26 shows assembled compressor 175, compressor shell front half 172 and compressor shell rear half 174 are made from suitable metal as is ordinarily used to house refrigeration compressors and can be powdered metal, casting, or stamped metal for example. Front half and rear half may be hermetically sealed or bolted together, whichever method best suits the particular application.

FIG. 27 shows shell front half 172 and shell rear half 174 separated, exposing hybrid compressor assembly 180.

FIG. 28 shows an exploded compressor assembly 180, having stator assemblies 128T, comprising powdered metal stators, bobbins, coils, O-rings and circlips 82 as previously introduced and may be wired for three phase drive scheme, or a synchronous AC drive scheme.

Compressor half 182 and 184 FIGS. 28, 29 and 31 are made of a non-ferrous powdered metal, cast metal, extruded metal, or machined from solid stock for example. Stator socket 87 is similar to stator sockets previously introduced. Intake ports 176 are elongated arced ports that allow the free entry of refrigeration into the suction sides of chamber 200.

Gas passages 204 are slots or grooves in the inner wall of compressor half 182 and 184. High pressure output port 178 joins case gas passages 204 across the top of compressor half 182 and 184, and it is closed on the outside of compressor half 182 and is open to the rear of case half 184 as is more clearly shown in FIG. 30 and FIG. 32.

Hybrid axial flux vane rotor assembly 190 comprises vane rotor 192 which is made of a non-ferrous metal or alloy, powdered or cast, or machined from stock. Permanent magnets 196 may be made of rare earth or other suitable materials to best serve the designs as will be known to those having ordinary skill in the art. Vanes 194 are made of non-ferrous metal and may be powdered metal, cast, or machined from stock for example. Vane rotor bearing 199 comprises a bearing material or assembly as will be specified by engineering calculations for a given version of the present invention and may comprise a roller clutch bearing when using the synchronous drive scheme.

Chamber sleeve 200 has an elliptical profile and is made of suitable predominantly non-ferrous and durable material such as powdered stainless steel. Chamber sleeve 200 further comprises refrigerant output holes 202 for the passage of compressed refrigerant therethrough.

Reed valve assembly 185 FIG. 29 and FIG. 31 is made of thin spring-steel and comprises a number of valve tabs 186 and a valve bend/arc 188.

It will readily be seen that operation of the hybrid axial flux vane compressor of the present invention is similar to that of vane compressors currently in use, with the addition of a hybrid axial flux vane rotor 190, and the associated stator assemblies 128T, that operate substantially as the previously described hybrid axial flux machines of the present invention. One embodiment is a 6 pole version of the hybrid axial flux machine of the present invention, FIG. 28 and FIG. 31, which can be driven with either a three phase current scheme, or synchronously.

### Four Pole Synchronous Refrigeration Compressor

In a second embodiment of a hybrid axial flux vane compressor a four pole version of a hybrid axial flux vane rotor assembly and associated stators FIG. 32 is made substantially with materials and features as described for the six pole version of FIG. 28, and when used in synchronous operation will provide a higher rotor speed than versions of the present inventions having more poles. When operated synchronously, a roller clutch bearing 198 is used.

Stator assemblies 128TPS are introduced to stator sockets 87 in each compressor case half 182 and 184, and held in place with circlips 82 as has been previously described. Alternately, stator assemblies 128TPS may be secured in place in stator sockets 87 with bolts (not shown), or other suitable securing methods. Another alternate embodiment of stator sockets 87 do not have through holes, but rather have closed bottoms of thin material integral with the surrounding material in stator socket 87 and case halves 182 and 184, which eliminate the need for O-rings to seal stator sockets 87, but O-rings could still be used to shock mount and align stator assemblies 128TPS or 210S in stator sockets 87.

A gasket (not shown) is introduced to inner periphery of case back half 184 prior to introducing sleeve 200 to case bad(half where sleeve 200 will press and seal against the gasket.

Reed valve assemblies 185 are then introduced to and pushed into reed valve passage 206 causing the bend/arc 188 to be compressed and held firmly between sleeve 200 and passage 206.

Vane rotor shaft (not shown) is introduced to vane rotor shaft hole 197, and vane rotor assembly 190 is mounted on the vane rotor shaft. Another gasket (not shown) is introduced to inner periphery of case front half 182 prior to bringing front half to fit over sleeve 200 and onto rotor shaft (not shown). Bolts and nuts (not shown), or other suitable methods of securing halves 182 and 184 together, are then used to hold the hybrid compressor assembly 180 together.

Assembly 180 is then encased and sealed between shell halves 172 and 174 to provide a closed environment suitable for refrigeration compressors. Note: an oil separator (not shown) may be included inside or outside of shell assembly 175 as is customary in refrigeration systems having refrigerants containing lubricating oils.

When properly charged with refrigerant, and properly connected electrically to a driver or controller circuit, hybrid axial flux vane rotor assembly 190 will be driven in a clockwise direction viewed from the left side of FIG. 26, FIG. 27, FIG. 28, FIG. 31, and FIG. 32. Centrifugal force will cause vanes 194 to press against and substantially seal against chamber sleeve 200. As the vanes 194 rotate around the axis of symmetry, they will alternately draw in refrigerant through intake ports 176 at a lower pressure, and compress the refrigerant and force it through chamber sleeve ports 202, where it will be driven through gas passages 204, and into high pressure output port 178 where it will then be directed through connective tubing (not shown) to circulate through other components exterior to hybrid axial flux compressor assembly, comprising a more complete refrigeration system, and then return to the interior of compressor shell assembly 175 to once again be drawn into intake ports 176 to repeat the cycle. In other embodiments, intake ports 176 and output ports 202 may be mirrored axially to allow for counter-clockwise rotation of vane rotor assembly 190.

As refrigerant is forced through ports 202 reed valve tabs 186 are pushed away from port 202 to allow the refrigerant to pass through to passages 206, and as vanes 194 pass over ports 202 and a lower pressure is suddenly presented to port 202, allowing tabs 186 to spring back over the outside of ports 202 and the higher pressure refrigerant in passages 204 to press against tabs 186 and seal against ports 202; preventing the return of the compressed refrigerant back into the interior of chamber 200.

### Hybrid Axial Flux Swash Plate Rotor

Still another alternative embodiment of the present invention comprises stator assemblies 128TPS with hybrid swash plate rotor 220 FIG. 33 Swash plate rotor 220 may be machined from solid stock, or formed from powdered metal, cast metal, or other suitable predominantly non-ferrous materials or combinations of materials using appropriate manufacturing methods, suited to the particular application it is intended for. Hybrid axial flux machines having swash plate rotors 220 may be utilized as the core mechanism driving an axial piston compressor (not shown) for example, or other machines like pumps (not shown) that may utilize swash plate mechanisms as are known to those skilled in the related arts.

### Hybrid Axial Flux Wobble Plate Rotor

Another alternative embodiment of the present invention somewhat related to the hybrid swash plate rotor is the hybrid wobble plate rotor (not shown). Using principles, mechanisms and components thoroughly described above, anyone having ordinary skill in the art of engineering and fabricating wobble plate mechanisms can incorporate these hybrid axial flux machines into their designs.

### Hybrid Axial Flux Eccentric Rotor

Yet another alternative embodiment of the present invention comprise stator assembly 100BU with an eccentric rotor 222 FIG. 34 and FIG. 35 Eccentric rotor 222 can be injection molded plastic, machined from solid materials, cast, or powdered non-ferrous metal, or other suitable material or combinations of materials. Rotational motion of eccentric 222 is that of a crank journal and can be utilized in a wide range of possible applications where such motion is most suited, such as driving diaphragm pumps, piston pumps, or operating other machines in a similar fashion as is known by those skilled in the relevant art. An eccentric rotor of this embodiment could even be used to drive a rotary piston pump or rotary piston refrigeration compressor for example. Eccentric rotor 222 can comprise one or more eccentrics offset to one another in a way that may, for example, balance loads on rotor bearing, not shown.

### Hybrid Axial Flux Cam Rotor

Another alternative embodiment of the present invention comprise stator assembly 100BU with a cam rotor 224 FIG. 36 and FIG. 37. Cam rotor 224 can be injection molded plastic, cast or powdered non-ferrous metal, or other suitable material or combinations of materials. Cam rotor 224 can have one or more cam lobes, the lobes may comprise a simple or irregularly shaped, as cams may be, and may be incorporated in any suitable machine where cams of this nature can be used

### Hybrid Axial Flux Roller Rotor

Yet another alternative embodiment of the present invention comprises a four pole stator assembly 100BU, peristaltic pump housing 226 and peristaltic pump rotor 227 and peristaltic pump roller 228 FIG. 38, each of which may be made of injection molded plastic for example, or other suitable material depending on the specific application they are intended for. Operation of the peristaltic pump is substantially the same as with other peristaltic pumps. Note that one embodiment of the peristaltic stator assembly 100BU is of the stepper variety as disclosed herein, coupled with a suitable electronic controller (not shown) to permit a high level of control of the pumping action.

Hybrid Axial Flux Spur Gear Mechanism

Another alternative embodiment of the present invention comprises a spur gear 250 driven by a stator assembly 100BU having gear rotor 252 FIG. 39. Both gears may be injection molded plastic or other suitable materials, including non-ferrous metals. In such an embodiment the electrical energy introduced to the coils will be converted to rotational mechanical energy.

### Hybrid Axial Flux Generators

However the reader will understand that rotational mechanical energy introduced to spur gear 250 can be converted to electrical energy. Generally, when possible, where the hybrid rotor can be the driven, the hybrid axial flux machine can function as a generator wherein mechanical energy is converted to electrical energy.

### Hybrid Axial Flux Planetary Gear Mechanism

Still another alternative embodiment of the present invention comprises a planetary gear assembly 238 having stator assembly 100BU, with gear rotor 244, planetary gears 242, and annular ring gear 240 FIG. 40. Each of these gears may be made of plastic or other suitable materials.

### Hybrid Axial Flux Pinion Rotor & Rack

Another alternative embodiment of the present invention comprises a stator assembly 100BU, with gear rotor 236, and rack gear 234 FIG. 41. Gear rotor 236 and rack gear 39 may be made of injection molded plastic, non-ferrous metals, or other suitable materials, depending on the specific application they are intended for.

Again, it should be noted that the modularity of these hybrid axial flux machines and mechanisms extends across these various additional embodiments so that 4 and 6 pole stators and their respective sockets, along with the various driver schemes, stepper, three phase, or synchronous can be used as desired with the various additional embodiments.

Hybrid axial flux rotors can be created other than those specifically illustrated herein. By way of example, we could use a hybrid axial flux machine or mechanism with a hybrid toothed belt pulley rotor, or other pulley and belt, or sprocket and chain drive, or a worm and screw gear set for motion control or other drive purposes that utilize these and other mechanisms. Another example would be using a rubber wheel on a hybrid axial flux rotor in conjunction with the hybrid axial flux driver to serve as a friction drive.

Similarly, there are uncounted possible ways to combine other features and or components with one or more axial flux hybrid rotors of the present invention to serve other purposes without straying from the spirit and scope of the hybrid axial flux machines and mechanisms of the present invention.

### Multiple Hybrid Axial Flux Drivers

One example of using multiple driver assemblies is the use of dual drivers on gear pumps wherein both gears of pump are driven (not shown), thus increasing the possible pressure from the gear pump while retaining a relatively small package.

Another example of using multiple driver assemblies is the use of two or more driver assemblies in a planetary gear system (not shown).

Synchronous drives can use 2, 4, 6 or more poles. Fewer poles will give a higher RPM figure, which may be beneficial in some applications, particularly the hybrid axial flux vane compressor which, at slower speeds will have a higher percentage of slip to overall flow volume, and at higher speeds will reduce slip as a percentage of flow but will generate more heat as the vanes wipe the chamber wall. 4 poles at 60 hz will give 900 RPM, which may be a very good speed for refrigeration applications with these compressors when engineered for that purpose. If four poles are used, then over-sized, or overlapping coils may be preferred since they will be able to carry more turns of heavy gauge wire that the refrigeration compressors for example, may use.

### Laminated Stack Stators

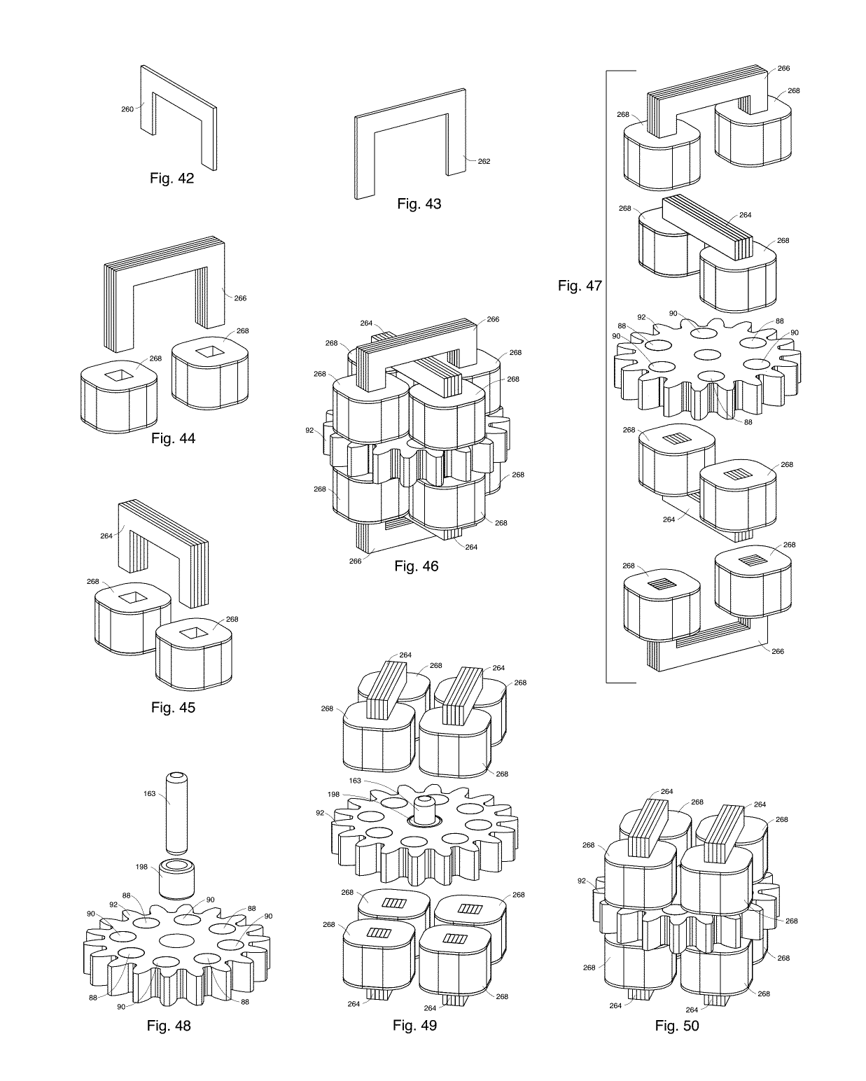

Electrical steel laminations as illustrated in FIG. 42 through FIG. 50 may be used as an alternative to powdered metal stators. A plurality of short lamination 260, FIG. 42 are brought together to form short lamination stack 264 FIG. 45. Square bobbins with coils 268 are mounted on the short laminated stack 264. A plurality of tall lamination 262 are brought together to form tall lamination stack 266 FIG. 44. Square bobbins with coils 268 are mounted on the tall lamination stack 266. Tall lamination stacks 266 with coils 268 are introduced over and perpendicular to short lamination stack 264 on both sides of gear rotor 92 FIG. 46 for use for example in a stepper style embodiment of the present invention. Bobbins with coils 268 are shown mounted flush with the tips of laminated stacks 264 and 266 FIG. 47, FIG. 49, but they may extend further beyond a face of bobbin coil 268.

Gear driver 92 FIG. 48 has 8 permanent magnets with magnetic fields disposed axially and alternating north-south-north-south-north-south-north-south. Roller clutch bearing 198 is mounted in the center of gear rotor 92 and rides on shaft 163. Short lamination stacks 264 with bobbins and coils 268, FIG. 49 are oriented parallel to one another in this synchronous version and do not need to use tall laminations that would cross over short stacks. FIG. 50 further illustrating the parallel lamination stacks 264 and their relationship with gear rotor 92. Anyone having ordinary skill in the art will be able to wire the coils appropriately for synchronous AC operation.

### Coiled Electrical Steel Stator

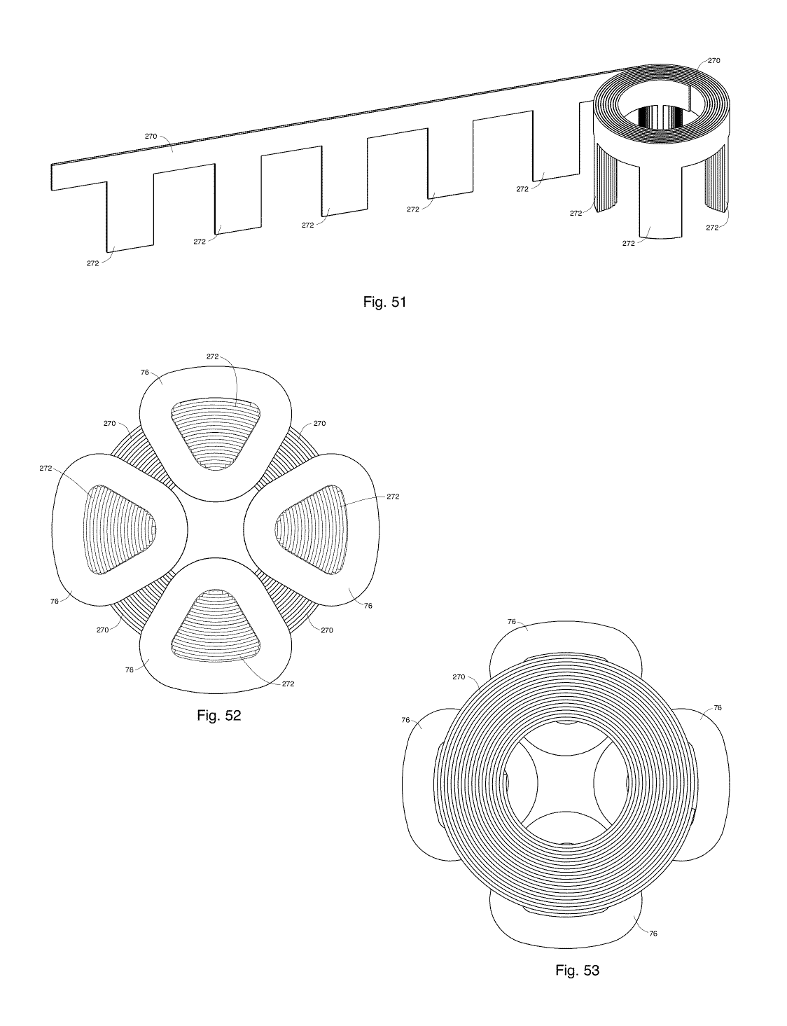

A properly notched strip of electrical steel FIG. 71 when coiled, brings flux return path 270 into substantially ring shaped spiral with core lamination tabs 272 forming laminated stator cores 272. FIG. 52 further illustrating coiled electrical steel stator of FIG. 51, now in bottom plan view and having bobbins 76 mounted on laminated stator cores 272. FIG. 53 further illustrating coiled electrical steel stator of FIG. 51 now in top plan view showing flux return path 270 and bobbins 76.

### Advantages

From the description above, a number of advantages of my hybrid axial flux machines and mechanisms become evident:

(a) They provide hybrid axial flux positive and non positive displacement pumps.
(b) They provide hybrid axial flux pumps having components common to both the motor and the pump, thereby reducing the amount of raw materials used, lowering the overall cost of tooling, and other manufacturing costs,
(c) They provide a wide variety of hybrid axial flux machines using an array of modular components that make them suited to a wide range of applications.
(d) They provide a wide variety of hybrid axial flux machines that can have stators covered and vented, sealed, or submersible as desired, using interchangeable modular components, or the stators may be exposed without covers.
(e) They allow for the use of modular driver and controller circuitry across a wide range of sizes, voltages, and power ratings of these hybrid machines, wherein the power handling components alone need to be matched to the power requirements of the associated hybrid axial flux machine.
(f) They allow for higher energy efficiency than is possible with comparable combinations of machines.
(g) They allow for hybrid axial flux stepper, multiphase, and synchronous motor drive schemes in a wide range of modular, hybrid axial flux machines.
(h) They provide for hybrid axial flux machines made of modular components which minimizes tooling, and stocking requirements to meet market demands for a range of these machines.
(i) They provide hybrid axial flux machines that can utilize a variety of controller and drive schemes, including simple, sophisticated, and integrated, or in some cases without driver or controller.
(j) They provide for hybrid axial flux synchronous machines using a roller clutch bearing in a hybrid rotor that allow rotation in one direction only.
(k) They provide for hybrid axial flux machines that are smaller, weigh less, use less raw material, are lower cost to tool, and manufacture.
(l) They provide for hybrid axial flux machines that have increased torque, energy density, and greater efficiency over the prior art.
(m)They provide for hybrid axial flux vane compressors
(n) They provide for hybrid axial flux swash plate compressors
(o) They provide for hybrid axial flux refrigeration compressors, particularly for electric and hybrid electric vehicles that are smaller and lighter than the prior art.
(p) They provide for hybrid axial flux drives and mechanisms having hybrid rotors including gear, vane, impeller, swash plate, eccentric, cam, roller, that can be used across a wide range of machines and mechanisms.
(q) They provide for modular discrete components that combine to make modular sub-assemblies that can then be used to create modular hybrid axial flux machines and mechanisms.
(r) They provide hybrid axial flux machines that are readily understood and can be implemented using currently supported motor drive schemes, such as bipolar stepper, unipolar stepper, multiphase, and synchronous, using existing logic and integrated circuits and discrete components, or with no driver or controller at all when using synchronous drive schemes.

### Operation of Invention

Many of the commonly known principles of operation of the various pump styles of the present invention are identical, or substantially similar to the commonly known principles employed in the related prior art, such as with gear pumps, vane pumps, and turbine type impeller pumps, vane and piston compressors, and other related machines and mechanisms.

Similarly, many of the commonly known principles of operation of the various motor styles of the present invention are identical, or very similar to the commonly known principles employed in the related prior art, such as with stepper motors, multi-phase motors, such as 3 phase motors, and synchronous motors.

The hybrid nature of the present invention brings together, and merges known principles of the rotors and impellers of a variety of pumps, compressors and other machines, including rotors having a swash plate, rotors having a wobble plate, rotors having one or more eccentrics, one or more cams, one or more rollers as with those commonly used in peristaltic pumps, etc. of the prior art, with the known principles of the rotors of electric motors such as stepper motors, multiphase motors, such as 3 phase motors, and synchronous motors, particularly those having permanent magnets in the rotor.

The combinations of numbers of poles used in the stators and rotors, and the orientation of the individual magnetic poles can vary from those illustrated herein without straying from the scope and spirit of the present invention. For example, there is a great deal of versatility in using rotors having 6 permanent magnets since 6 pole rotors, along with other modular components of the present invention can be used in stepper, 3 phase, and synchronous styles of the present invention with only slight changes in orientation of the permanent magnets for the 3 phase versions, and the inclusion of a roller clutch bearing in the synchronous versions. However, rotors having other numbers permanent magnets can be used advantageously in some embodiments of the present invention, as with the synchronous compressor of FIG. 32 which has 4 permanent magnets in the rotor. Similarly, rotors having 2 permanent magnets may be used advantageously in other synchronous motor embodiments.

There is also a great deal of versatility in using 4 and 6 pole stators of the present invention in that in some embodiments the same bobbins and coils can be used on both 4 and 6 pole stators, as can the same O-rings, and circlips or retainer rings used to hold the stators in place. Additionally, stator socket inserts can be used in the mold used to manufacture the housings for the pumps and compressors and other machines of the present invention and can be changed out to accommodate either the 4 or 6 pole stators, thus greatly increasing the use of the modular components to create a wide range of products. Nevertheless, other numbers of poles and combinations of numbers of poles on stators and rotors is possible, and stator sockets and stator socket inserts can match the stators having other numbers of poles.

It should also be noted that the described embodiments of the present invention can be scaled up or down to suit desired purposes and, applications, for example the pumps can be sized and operated to pump less than a few ounces per minute to many gallons per minute. They can made to generate nominal head pressure, or very significant head pressure, as with compressors. They can be scaled from a few watts to multiple kilowatts, from fractional horsepower to multiple horsepower. The pump housings may for example, be lightweight injection molded plastics, or they may be heavier duty cast metal, or powdered metal, or machined out of solid material if desired. Similarly, the various components can be manufactured of materials and combinations of materials, using manufacturing methods suited to the size, pressures, and other specific purposes for which they are intended.

While the hybrid axial flux machines of the present invention can be scaled to any suitable size, it will be advantageous to manufacture a range of standardized sizes, graduating them incrementally, for example using the outside diameter of the stator as a base of measurement we can scale up or down in half inch steps for example. Using this basis we could produce 1.5″, 2″, 2.5″, 3″, 3.5″ pumps and so on. Once core components or driver assemblies for one size of hybrid axial flux machines of the present invention are made, stators, coils, rotors, magnets, etc. we can then create various housings to use them in, such as gear pump, vane pump, turbine pumps, and other machines and mechanisms. Then we can make core components for a second size of hybrid axial flux machines of the present invention, and various housings to use them in, and so on to add greatly to the possible variations.

We could easily choose another basis for incremental changes in size, and the increments do not necessarily have to be uniform. Additionally, while creating a range of standard sizes, there may be benefits in producing products that deviate from these standards.

For purposes of communicating a clear differentiation between drivers and controllers; drivers are defined as the minimal electronics needed to operate the hybrid axial flux machines of the present invention, whereas controllers may have added functionality, including one or more timers, input options and or associated circuitry and or hardware that could regulate the speed of a pump of the present invention, or pressure produced, and so on. In either case, driver or controller, it should be noted that anyone skilled in the relevant art can bring together existing components to create satisfactory drivers and controllers. In some cases these may comprise a single integrated circuit with minimal numbers of discreet components. In other cases the controllers may comprise more complex circuitry, and or added hardware. In still other instances it may be most beneficial to integrate the driver, and or controllers into hardware and or software being used to manage other aspects of an overall system or machine to which the hybrid axial flux machine of the present invention is to be a part of.

Additionally, the drivers and controllers of the present invention can be used across the entire range of sizes and styles of the hybrid axial flux machines that use drivers and controllers with few to no changes. The power switching elements of the driver and controller circuits needing to be matched to the power consumption of the motor, but otherwise the driving or controlling circuits can be the same. This greatly simplifies implementing, and introducing the hybrid axial flux machines of the present invention globally, by allowing easy standardization of drivers, controllers, integrated. and embedded systems. It also makes the manufacture of special purpose integrated circuits for operating these machines much more realizable through higher production volumes. This also makes it easier for these machines to be used throughout various industries around the world for uncounted purposes by enabling engineers, inventors, artisans and craftspersons to be, able to more easily use these devices in their machinery, systems, products, arts and crafts.

In the case of synchronous styles of the present invention the addition of a roller clutch bearing in the center of the hybrid rotor limits rotation to one direction only, flipping the rotor, or the roller clutch bearing over allows it to rotate in the opposite direction. However, because it is synchronous, no controller or driver is necessary. Simply providing appropriate power, e.g. synchronous AC, will cause the the hybrid axial flux machine to operate. Alternately, a roller clutch bearing could be used in the driven gear 94 FIG. 3 of a gear pump, which would also serve to limit rotation of the hybrid gear rotor to one direction only.

While no lead wires are shown in the illustrations of the present invention, those having ordinary skill in the relevant arts will readily recognize how the leads are intended to be brought out of the coils and brought together to be introduced to drivers and controllers where needed, or to be connected directly to a power supply, as with the synchronous versions. Similarly, coil winding orientations are given to be understood by those having ordinary skill in the relevant arts. Briefly, stepper wiring schemes may be bipolar, or unipolar, and if wiring leads for both bipolar and unipolar are provided to the user, then it is considered universal wiring and a user can choose either scheme. Briefly, 6 pole stators may be wired for three phase or for synchronous operation. Keeping in mind that other numbers and combinations of stator and rotor poles may be devised by those having ordinary skill in the art. Also, 4 pole stators may be wired for stepper or synchronous, but 4 pole synchronous stators require 4 permanent magnets in the hybrid rotors, which is acceptable, but deviates from the use of 6 pole hybrid rotors across the listed drive schemes.

Generally, electromagnets comprising multiple sets of coils on stators made of suitable material such as insulated powdered metal or suitable electrical steel components, such as laminations are energized and de-energized in a series of steps that urge the permanent magnets in the associated hybrid rotor to rotate in the resulting effectively rotating electromagnetic field. These steps are most clearly distinct in the stepper motor styles of the present invention, however, for ease of understanding we can also describe the more sinuously changing electromagnetic fields of 3 phase and synchronous styles of the present invention as a series of steps as well.

Referring now to FIGS. 1 through 6C stator 71, bobbins 76, coils 78, O-rings 80 and circlip 82, are brought together as illustrated to create bipolar stator assembly 100B. Stator assembly 100B is then introduced to stator socket 83 FIG. 12, in each of housing sides 51 and 52 and affixed thereto with circlip 82. If stator assemblies 100B are intended to be covered and vented they will be covered and protected with a vented stator cup 82, and vented stator cap 64. If stator assemblies 100B are to be covered and sealed they will be covered with sealed stator cup 54 and stator cap 56. If the stator assemblies are to be potted for submersibility then sealed stator cup 54 is used, potting material (not shown) is poured in, and stator cap 56 is affixed to stator cup 54. Lead wires (not shown) are brought out of stator cap through wire passage 66.

Magnet set 91 with permanent magnets having alternating pole orientation north-south-north-south-north-south, or N-S-N-S-N-S, or 90-88-90-88-90-88, are inserted and held firmly in gear rotor 92 to create gear rotor assembly 98. Gear shafts 96 are introduced to gear shaft holes 97 in one of the housing halves 51 or 52, and gear rotor assembly is placed on shaft 96 and over the stator assembly 1008. Driven gear 94 is placed on gear shaft 95 to engage and mesh with gear rotor 98. A gasket (not shown) is placed on the mating surface of either housing half, 51 or 52 and the remaining housing half is brought to engage the first half and fastened together with screws (not shown) and nuts (not shown).

Properly assembled and connected to an appropriate driver or controller circuit (not shown), rotation of the gear rotor using a bipolar stepper scheme, as is known by those having ordinary skill in the art, substantially follows the steps shown in FIG. 6A through FIG. 6C as the ensuing description expands upon;

Note; for clarity stator 71 and gear rotor 92 are not shown in the ensuing description but it is understood that all coils are mounted on stator 71 as shown in FIG. 3, FIG. 4 and FIG. 5, and permanent magnets N and S are mounted in gear rotor 92. Thus, coil 101 and coil 106 are wired to produce opposite poles to one another (facing out of the page to set a convention). Similarly, coil 104 and coil 108 are wired to produce opposite poles to one another. The relative electromagnetic poles of the respective coils when energized throughout the steps described will become more readily apparent as the description proceeds.

With FIG. 6A as an arbitrary starting point of a continuous cycle, coils 101 and 106 are energized so that coil 101 creates a magnetic south pole and attracts a permanent magnet N, north pole to align most closely with coil 101. At the same time coil 104 is energized to create a magnetic north pole and attracts the permanent magnet S, south pole, on the opposite side of stator/coil scheme 111 to align most closely associated with coil 106.

The description immediately above is for one stator assembly 1008 on one side of gear rotor 98. The mating stator assembly 100B located on the opposite side of gear rotor assembly 98 is energized and de-energized simultaneously in a manner that presents the opposite electromagnetic poles to the other side of permanent magnets 88 and 90 and completes a continuous electromagnetic circuit with magnetic flux 110 passing through stator cores 70, flux return path 68 FIG. 3, across axial gap (not shown), and through permanent magnets 88 and 90 in hybrid gear rotor 98. It is to be understood that for each step in this description, corresponding sets of coils 101, 104, 106 and 108 on each side of hybrid gear rotor 98 are operated together and cooperate to urge hybrid gear rotor 98 to rotate in the desired direction.

Progressing to the next step shown in FIG. 6B, coil 102 and 106 are de-energized, and coils 104 and 108 are energized. The resulting action is that magnet S adjacent to coil 104 and magnet N adjacent to coil 108 are drawn into alignment most closely associated with coil 104 and 108. The resulting hybrid gear rotor motion is 30 degree rotation in a clockwise direction.

In the next step shown in FIG. 6C directly below FIG. 6B, coils 104 and 108 are de-energized and coils 101 and 106 are energized with current flowing in an opposite direction from that used in the starting position FIG. 6A, producing opposite electromagnet poles. The resulting action is that magnet S adjacent to coil 101 and magnet N adjacent to coil 106 are drawn into alignment with coil 101 and 106 respectively, again causing a 30 degree clockwise rotation of axial flux gear rotor 98.

In the next step FIG. 6D coils 101 and 106 are de-energized, while coils 104 and 108 are energized in opposite polarities from their last energizing, and the magnet N adjacent to coil 104 and magnet S adjacent coil 108 are drawn into alignment with coil 104 and 108 respectively, again causing a 30 degree clockwise rotation of axial flux gear rotor 98.

The reader will see three steps have been taken to cause the hybrid axial flux rotor 98 to rotate 90 degrees. Continuing in the same fashion for 12 steps will complete one full revolution of hybrid axial flux rotor 98.

The above description is for a simple bipolar stepper scheme and anyone skilled in the art of stepper motors will also be able to wire and control the motor using a unipolar stepper scheme. Additionally, those skilled in the art of stepper motors and gear pumps will be able to drive pump 50 at desired speeds and force, to deliver desired volumes of fluid, within desired pressure ranges, within the capacity of a given pump 50.

Although the present invention does not encompass electronic drivers or controllers, generally speaking the speed with which steps illustrated in FIG. 6A through FIG. 6C are taken will determine the speed of gear pump 50. Since it takes 12 steps of the electromagnetic circuit to rotate the gear rotor 360 degrees, it would take 1,200 steps per minute to produce a speed of 100 RPM in the gear pump. The speed and displacement of the gear pump can be used to determine flow or dose.

Similarly, the amount of energy directed through the motor will determine the pressure that can be generated with pump 50. Hence it will be seen that simple circuits can be used to drive the hybrid axial gear pumps 50 with an accuracy not possible with centrifugal hybrid pumps.

Pump 51 can also be driven with a simple circuit (not shown) that causes it to run at a fixed speed for example. Another variation on a driver or controller would be to employ power wave management, to ramp up or down, or more closely control the power used to energize the coils. This added control can be used to simulate a more sinusoidal action in the circuit for example. It could also be use to regulate pressure produced by the pump through control of the power used to energize the coils. Another possible use of power wave management may be to reduce vibrations produced by the machine by altering the profile of the power wave used to drive the machine. Another variation on controlling pump 50 electronically would be with a circuit that accepts an input from an external sensor that could vary resistance in the circuit for example. We could connect a pressure sensor, or thermal sensor, or light sensor, or other sensor to vary the speed of pump 50 according to the desired outcome, speeding up or slowing down pump 50. These control schemes can be used alone or in combination to achieve desired results, and other more sophisticated control schemes can be used to run pump 50 and other hybrid axial flux machines.

If the power rating of pump 50 is very low, it is possible to drive it directly from the output of the logic or other driver or controller circuitry, using low voltages. However, as the power rating goes up, power handling components rated for the power required to run pump 50 will need to be included in the circuit. Such power handling components can then be controlled by the output of the control or driver circuitry. Otherwise the same circuit can be used to run all sizes, or all power ratings of the stepper styles of these hybrid axial flux machines, from the smallest to the largest, from a few watts, to multiple kilowatts.

The above description of driver and control schemes being several examples of possibilities to better illustrate how one may operate the hybrid axial flux gear pump of the present invention using a bipolar stepper scheme. As mentioned, one skilled in the art will be able to devise other ways to drive and or control the stepper style of these hybrid axial flux gear pumps, using bipolar and unipolar stepper schemes.

Referring now to FIGS. 7 through 11D stator 129TP, bobbins 76, coils 78, O-rings 80 and circlip 82, are brought together as illustrated to create stator assembly 128TP which is wired for Three Phase operation. Stator assembly 128TP is then introduced to stator socket 87 in each of housing sides 114 and 116 and affixed thereto with circlip 82. If stator assemblies 128TP are intended to be vented they will be covered and protected with a vented stator cup 112 (not shown). If stator assemblies 128TP are to be sealed they will be covered with sealed stator cup 112. If stator assemblies 128TP are to be potted for submersibility for example, then potting material (not shown) is poured over stator assembly 128TP through a hole in stator cup 112 (not shown), and a stator cap may be affixed to stator cup 112. Lead wires (not shown) are brought out of stator cup 112 through a wire passage (not shown).

Magnet set 91 (shown mounted in rotor 122) with permanent magnets having alternating pole orientation north-north-north-south-south-south, or N-N-N-S-S-S, or 90-90-90-88-88-88, are inserted and held firmly in vane rotor 122 using adhesive (not shown), or other suitable methods for holding the magnets in place. Vane rotor shaft 131 is introduced to vane rotor shaft hole 127 in one of the housing halves 114 or 116, and vane rotor 122 with magnets 88 and 90 is placed on shaft 131 and centered over the stator assembly 128T. Vanes 124 are then introduced to vane slots 123. A gasket (not shown) is placed on the mating surface of either housing half, 114 or 116 and the remaining housing half is brought to engage the first half and affixed together with screws (not shown) and nuts (not shown).

Properly assembled and connected to an appropriate driver or controller circuit (not shown), rotation of the vane rotor using a three phase motor scheme substantially follows the steps shown in FIG. 11A through FIG. 11D as the ensuing description expands upon;

As in the first embodiment there are stator assemblies 128TP on both sides of the rotor and they present opposite electromagnetic poles to opposite sides of permanent magnets 88 and 90 and cooperate to complete the electromagnetic flux circuit 110 across axial gaps (not shown) through the permanent magnets 88 and 90 and urge the rotor in the desired direction at the desired speed with the desired force.

Coils diametrically opposed across the center of the axis of rotation are wired together and powered by the same phase of current provided, and oriented in opposite directions so the electromagnetic poles produced are of opposite polarity and generate a substantially continuous loop of electromagnetic flux through them.

With FIG. 11A as an arbitrary starting point of a continuous cycle, coils 101 and 106 are most highly energized at the peak of current flow, illustrated by larger flux loop 110, within the phase they are connected to. Coils 103 and 106 are energized with a smaller, though rising current flow, while coils 108 and 105 are energized with a smaller and falling current flow. The electromagnetic poles presented attract permanent magnets N and S as illustrated.

In the next step, illustrated in FIG. 11B, the electromagnetic fields being generated in coils 103 and 107 are peaking in strength, while the electromagnetic fields in coils 101 and 106 are falling in strength and the field in coils 105 and 108 are rising in strength and permanent magnets 88 and 90 are then urged to follow the electromagnetic field 60° to align with the new position of the electromagnetic flux circuits 110.

As illustrated in FIG. 11C, directly below FIG. 11B, the electromagnetic field advances 60° further, with the peak current flow through coils 105 and 108, falling current flow in coils 103 and 107, and rising current flow in coils 106 and 101, which urges permanent magnets 88 and 90 to rotate in the clockwise direction to the 120° position.

In a third step, illustrated in FIG. 11D to the left of FIG. 11C, the electromagnetic field advances 60° further, with the peak current flow through coils 106 and 101, falling current flow in coils 105 and 108, with rising current flows in coils 107 and 103, which urges permanent magnets 88 and 90 to rotate in the clockwise direction a further 60° to the 180° position.

The cycle described continues repeatedly as long as 3 phase current is applied to the coils as described, causing vane rotor assembly 130 to rotate in the desired direction at a speed that corresponds to the frequency of the applied AC current, and with a force corresponding to the amount of electromagnetic flux generated in coils of stator assemblies 128TP.

Given that three phase alternating current is commonly inverted from a DC current source, it is possible to control the frequency of the alternating current and therefore the speed of the hybrid axial flux machine being driven by it using commonly available components for such purposes. Engineers, artisans, and craftsmen the world over are familiar these three phase motor drivers and controllers and will be able to easily include these new hybrid axial flux machines that use three phase power, into their products, systems, machines and so on.

It should be readily seen by the reader that these new inventions can be introduced to a market already familiar with how to use and operate them and therefore they can be adopted quickly in global markets and operated in a wide array of possible applications.

As with the previous embodiment, drivers and controllers can be simple or sophisticated. They can stand alone, or they can be integrated with other circuitry and components to the greatest advantage for a given application. They can be designed for general purposes to serve a wide array of applications, or they may be customized to better fit specific applications.

Referring now to FIGS. 14 through FIG. 20 stator assembly 128S which is wired for synchronous operation is introduced to stator socket 87 and affixed thereto with circlip 82. Stator socket 87 is integral with inner shell face 159 and will be affixed to inner shell 158 using commonly used methods such as adhesives, sonic welding, infrared, or other welding techniques, or with mating threaded members (not shown) etc.

Lead wires (not shown) are brought out of inner shell 158 through wire passage tube 167. Tube 167 further extends through hole 153 in outer shell 152. Lead wires from each side of hybrid axial flux turbine pump 150 can then be joined into a single set of leads (not shown) to be connected to a suitable power source (not shown) as will be known to those having ordinary skill in the art.

O-ring 156 is placed on tube 167 prior to bringing inner shell 158 into outer shell 152. Inner shell 158 is then aligned properly to outer shell 152 to orient the intake and output ports 151 relative to one another as desired. The reader will understand it is necessary to key, or align stator assemblies 128S in each side of pump 150 so they will mate properly with one another during assembly and cooperate together in operation. There a various methods for making this alignment easier, for example; by providing alignment marks 69A on stator 129 FIG. 21, and alignment marks 69B on both sides of stator socket 87 the orientation of the stator to the socket will be known even after assembly 128S is joined with inner shell 158. It is assumed the coils 78 have been wired as to key them to the stators 129 during assembly of stator assemblies 128S.

An additional alignment is necessary to align inner shells 158 to one another. This too can be accomplished through a variety of methods. For example, one or more of the rotor spacers 155 may be longer on one side and shorter on the other side of inner shell 158, to create an effective keyway and key so they may only come together properly in one orientation relative to one another.

Before aligning stationary blades 165 with stationary blade grooves 166 and bringing inner shell 158 into outer shell 152, sliding blades 165 into grooves 166, and directing tube 167 through hole 153, causing O-ring 156 to seat against wire passage tube ledge 168 and inner surface of outer shell 152 (not shown). Jamb nuts 154 are then threaded onto end of wire passage tube 164 compressing O-ring 156, sealing between inner shell 158 and outer shell 152 and holding inner shell 158 tight to outer shell 152.

Permanent magnets 88 and 90 are introduced and affixed to turbine impeller 160 with an alternating pole orientation sequence of North-South-North-South-North-South, or N-S-N-S-N-S, or 90-88-90-88-90-88.

Rotor shaft 163 is introduced to turbine rotor shaft hole 164 and turbine rotor assembly 160 is positioned on rotor shaft 163 being sure to orient the turbine rotor with the correct side up so the impeller blades 162 will urge water or other fluid in the proper direction. Impeller blades 162 as illustrated are for operation in one direction only, however, it is possible to create impeller blades (not shown) that may operate in either direction.

A gasket, not shown, is placed on the mating surface 157 of one of the outer shell half 152 before bringing the second shell half 152 together with it and affixing it with screws (not shown) and nuts (not shown) with the first shell half 152.

Assembled hybrid axial flux turbine pump 150 can then be plumbed into service using methods known to those having ordinary skill in the art.

With FIG. 18A as an arbitrary starting point to describe the steps to induce rotary motion in this synchronous version of these hybrid axial flux machines; in the center of the illustration is a roller clutch bearing 198 FIG. 16 that allows rotation in one direction only. In this description we assume only clockwise rotation is possible. Coils 101, 105, and 107 produce south electromagnetic poles when energized, thus attracting permanent magnets S to align with them. Simultaneously, coils 103, 106 and 108 produce north electromagnetic poles, and attract permanent magnets N to align with them. Electromagnetic flux circuit 110 is substantially of the same strength through all coils simultaneously, rising, peaking, and falling together at the same time.

In the next step illustrated in FIG. 18B, the alternating current supplied to coils 101, 103, 105,106, 107, and 108 reverses direction and the respective coils are energized and create the opposite magnetic polarity, which will repel the permanent magnets from their alignment, and since they are only allowed to rotate in one direction by virtue of the roller clutch bearing 198, the permanent magnets must rotate in a clockwise direction, away from like poles, towards unlike poles, as illustrated in FIG. 18B.

The above cycle continues as the current alternates repeatedly, and urges the permanent magnets to continuously rotate in a clockwise direction.

FIG. 19 illustrates a four pole version of the synchronous hybrid axial flux machine of the present invention. Alternating current electricity flowing through coils 101, 104, 106, and 108 will produce alternating electromagnetic poles that will urge a rotor having corresponding permanent magnets N and S to rotate as described with the six pole synchronous hybrid axial flux machine of the present invention, and roller clutch bearing 198 will only allow rotation in one direction. Each half cycle of the alternating current will urge the four pole axial flux rotor 90°. This cycle continues as the current alternates repeatedly, and urges the permanent magnets to continuously rotate in a clockwise direction.

FIG. 20 illustrates a two pole version of the synchronous hybrid axial flux machine of the present invention. Alternating current electricity flowing through coils 101 and 106 will produce alternating electromagnetic poles that will urge a rotor having corresponding permanent magnets N and S to rotate as described with the four pole synchronous hybrid axial flux machine of the present invention, and roller clutch bearing 198 will only allow rotation in one direction. Each half cycle of the alternating current will urge the four pole axial flux rotor 60°. This cycle continues as the current alternates repeatedly, and urges the permanent magnets to continuously rotate in a clockwise direction.

These synchronous machines need no added driver or controller circuitry in order to operate. Switches, timers, and other methods for turning these machines on or off may be provided. Additionally, if a DC source of power is used to create inverted AC power, if the inverter can change the frequency of the alternating current, then the speed of these machines can be changed. However, the described embodiment of these synchronous hybrid axial flux machines is to connect them to existing AC line frequencies and voltages, 60 Hz, 110 AC for example, just as radial flux synchronous pond and aquarium pumps of the prior art are powered.

Referring now to FIG. 21 through 25 the reader will see a very wide range of options that could be selected from when constructing various hybrid axial flux machines of the present invention. Using a few basic parts; O-rings 80, bobbins 76, coils 78, four pole stators 71, six pole stators 129, and circlip 82, we can create modular stator assemblies 100BU, which may be wired for bipolar stepper, or unipolar stepper, or universal stepper, and 128TPS, which may be wired for Three Phase, or Synchronous. Further, using permanent magnets 89 and gear rotors 98, vane rotors 130, and turbine impellers 160 to create modular hybrid gear, vane and turbine rotors. The inclusion of a roller clutch bearing in the center of any of these hybrid rotors making them suited to synchronous drive schemes. These modular stators, and hybrid rotors can then be used to assemble gear pump 50, vane pump 125 or turbine pump 150. Gear pump 50 and vane pump 125 may optionally have a stator cup and cap that is sealed or vented to serve the intended purpose. Gear pump 50 and vane pump 125 and turbine pump 150 may also be potted. Coils 78 may be optimally wound for a variety of voltages. Pump housings may be manufactured using a variety of materials such as those listed in table FIG. 25 to best suit the purpose they are intended for. Intake and output ports can be oriented in 8 different combinations of positions.

Wiring of these hybrid axial flux machines will be according to the desired motor drive scheme as is known to those having ordinary skill in the art. Drivers and controllers, when needed can be simple, or sophisticated, and they may also be integrated into other available circuitry.

It will be seen that these modular components can fit together in various combinations in each of the pump housings. For example, gear pump 50 can have a stepper, three phase, or synchronous hybrid motor of the present invention. Similarly, vane pump 125 and the turbine pump 150 can also have any of the three general motor drive schemes.

Bobbins 76 can be sized to contain a coil 78 large enough for the maximum intended purpose, and a large size bobbin 76 can also contain a smaller coil 78 to optimize using it with a different applied voltage.

The reader will see a very wide range of hybrid axial flux pumps can be created using a minimum number of parts that are brought together in sub-assemblies that can readily be used to create final products. However, it should also be noted that there are uncounted options for customization of these hybrid axial flux pumps for even more specific uses including custom materials, custom stators, custom bobbins, and custom windings.

### CONCLUSIONS, RAMIFICATIONS, AND SCOPE OF THE INVENTION

Accordingly, the reader will see that the hybrid axial flux machines and mechanisms of the present invention have many varied advantages over the prior art in that

axial flux electrical motors allow for stronger magnetic fields, and greater power at slower speeds than their radial counterparts.
axial flux electrical motors are characterized by increased energy density, and higher torque than their radial counterparts.
they use less raw materials than similar machines having separate motors;
they are smaller, lighter, and more energy efficient than the prior art;
they can use many modular components across a wide range of machines;
they can be made in a range of standard sizes to help in their introduction and use across myriad industries worldwide.
they can be made to use standardized voltages, such as 6, 12, 24 and other voltages and they may be DC or AC including line voltages such as 110 and 220 and they can be customized when so desired to operate on what could be considered non-standard voltages.
they can utilize standard a stepper motor drive scheme, a multi-phase drive scheme, or synchronous AC drive
they can be customized in various ways to further enhance or optimize their use in specific applications as with custom sizes, custom materials, etc.
they can use modular simple driver circuitry across a very wide range of different models, including different sizes, voltages, wattages, etc.;
they can use modular sophisticated control circuitry across a very wide range of different models, including different sizes, voltages, wattages, etc.;
they can use driver and controller circuitry that can be integrated in other circuitry used in an overall system or machine of which the hybrid axial flux machine is a part of;
they can include a roller clutch bearing to obviate the need for driver or controller circuitry when using a synchronous AC drive scheme;
Their modular components can be used to make a wide range of machines including;
hybrid axial flux gear pumps, with open, sealed, vented or potted stators.
hybrid axial flux vane pumps, with open, sealed, vented or potted stators.
hybrid axial flux turbine type, axial flow pumps,
hybrid axial flux vane type refrigeration compressors,
hybrid axial flux swash plate/axial piston refrigeration compressors,
hybrid axial flux peristaltic pumps, with open, sealed, vented, or potted stators.
hybrid axial flux diaphragm pumps, with open, sealed, vented, or potted stators.
hybrid axial flux rotary piston pumps, with open, sealed, vented, or potted stators.
hybrid axial flux swash plate machines and mechanisms,
hybrid axial flux wobble plate machines and mechanisms,
hybrid axial flux cam operated machines and mechanisms,
hybrid axial flux eccentric rotor driven machines and mechanisms,
hybrid axial flux linear motion drives and mechanisms,
hybrid axial flux rotary motion drives and mechanisms,
hybrid axial flux planetary gear drives and mechanisms,
hybrid axial flux electric generators,
a wide range of hybrid axial flux pumps suitable for food processing, beverages, CPU cooling, chemical transfer, oil pumps in machinery, cutting fluid pumps, dosing, condensate removal, vending machines, photovoltaic panel cooling, solar water heaters, rainwater harvesting, livestock watering, fountains, statuary, art, etc.
hybrid axial flux pumps for electric and hybrid electric automotive uses, including air conditioning compressors, engine coolant, auxiliary coolant, inverter coolant, battery coolant, heater core, fuel, brake actuator, power steering, fuel cells, dynox scr, etc.
hybrid axial flux pumps and compressors for other automotive and other mobile uses including busses, RV's, trucks, trains, airplanes, etc.
hybrid axial flux pumps for agricultural uses, including livestock watering, livestock sprayers, crop sprayers, hydroponics, irrigation, etc.
hybrid axial flux air conditioning uses, including window units, central AC, heat pumps, commercial AC, industrial AC, etc.
hybrid axial flux compressors for refrigeration uses including small refrigerators for dorms, offices and hotel rooms, etc., residential kitchen refrigerators, commercial refrigeration, industrial refrigeration, etc.
hybrid axial flux machines for aerospace, military, and medical uses, including pumps and compressors in satellites, space vehicles and space stations, etc. where reduced weight and size, reliability and energy efficiency are all very important.

Although the description above contains many specificities, these should not be construed as limiting the scope of the invention but as merely providing illustrations of some of the presently described embodiments of the invention. For example, the stators may be made of electrical steel laminations in a variety of suitable configurations, or with other suitable materials. The stator sockets may be sealed across the bottom, obviating the need for O-rings on the stators to provide the seal. Instead of using a circlip or retaining ring to hold the stator in place other

1. An axial flux motor comprising a stator-coil assembly on at least one side of at least one rotor, said stator-coil assembly comprising one of a 4 pole stator, or a 6 pole stator, said motor further comprising a 6 pole rotor, said rotor comprising one or more magnets, said magnets comprising one of a pattern of alternating poles N-S-N-S-N-S on each side of said rotor for a stepper style and a synchronous style electromagnetic drive scheme, or a pattern of alternating poles N-N-N-S-S-S on each side of said rotor for a three phase style electromagnetic drive scheme.

2. The motor of claim 1, wherein said motor further comprises components that can be interchanged and or wired differently to create different types of motor, said different types of motor comprising stepper style motor, three phase motor, and synchronous motor, said components comprising stators, coils, stator sockets, and rotors.

3. A hybrid axial flux motor-machine comprising a stator-coil assembly on at least one side of at least one rotor-driver, said rotor-driver comprising one or more magnets, said rotor further comprising a mechanical driver element, said mechanical driver element comprising one or more of a driver gear of a gear pump, a rotor of a vane pump, an impeller of a turbine type axial flow pump, a rotor of a vane compressor, a swash plate, a wobble plate, an eccentric, a cam, a roller-rotor, a spur gear, a sprocket, a pulley, a toothed belt pulley, a friction wheel, or a roller-clutch bearing.

4. The hybrid motor-machine of claim 3, wherein said motor-machine further comprises components that can be interchanged to create a different types of machines, said components comprising one or more of a driver gear of a gear pump, a rotor of a vane pump, an impeller of a turbine type axial flow pump, a rotor of a vane compressor, a swash plate, a wobble plate, an eccentric, a cam, a roller-rotor, a spur gear, a sprocket, a pulley, a toothed belt pulley, a friction wheel, a roller-clutch bearing, and housings suited to said components said different type of machines comprising pumps, compressors, generators, linear motion machine, and rotary motion machines.

5. A stator comprising either four or six stator cores, said cores extending from a flux return path, said four or six cores comprising substantially identical cross-sections.

6. A bobbin comprising geometry so as to fit on stators having either four or six cores.

7. The bobbin of claim 6, wherein four of said bobbins may fit in a single layer on a stator having four cores, and six of said bobbins may fit in two layers on a stator having six cores.

8. Hybrid axial flux motor-machines comprising one or more stators comprised of flat stacks of laminated electrical steel, pairs of said stators oriented parallel to one another when used in a synchronous style electromagnetic drive scheme, and perpendicular to one another with one stator crossing over the other when used in a stepper style electromagnetic drive scheme, or crossing over one another in any other suitable number at suitable angles when used in a multi-phase electromagnetic drive scheme.

9. A method of making axial flux motors utilizing one or more modular components, said one or more modular components comprising magnets, bobbins, coils, four or six pole stators, O-rings, circlips and or other suitable retaining rings, vented stator covers, sealed stator covers, stator sockets with different numbers of holes to accommodate stators having different numbers of cores, and housings suited to said modular components.

10. A method of making one or more hybrid axial flux electric motor-machines utilizing one or more modular components, said one or more modular components comprising magnets, bobbins, coils, four or six pole stators, O-rings, circlips and or other suitable retaining rings, vented stator covers, sealed stator covers, spur gear drivers, vane rotors, axial flow impellers, swash plates, wobble plates, cams, eccentrics, friction wheels, roller-rotors, roller-clutch bearings, associated mechanisms, stator sockets with different numbers of holes to accommodate stators having different numbers of cores or poles, and housings suited to said modular components.

11. The method of claim 9, wherein one or more motor-machine components are substantially machined from solid stock, or formed from powdered metal, cast metal, injection molded plastic, or other suitable manufacturing technique using predominantly non-ferrous materials or combinations thereof.

12. A hybrid axial flux generator-machine comprising one or more axial flux electric generator, said generator comprising at least one hybrid rotor-driven element, wherein said rotor element comprises one or more magnets, said rotor element further comprising at least one mechanical energy transmission means of gears, notched belt pulleys, pulleys, sprockets, friction wheels, hydraulic impellers, or pneumatic impellers.
